(19) United States
(12) Patent Application Publication
(10) Pub. No.: US 2009/0276541 A1
(43) Pub. Date: Nov. 5, 2009

(54) GRAPHICAL DATA PROCESSING

(75) Inventors: Gordon D. LOCK, Hook (GB); Andrew Bryce, Cranleigh (GB); Jeremy Barnsley, Newcastle-Upon-Tyne (GB)

Correspondence Address: NIXON & VANDERHYE, PC, 901 NORTH GLEBE ROAD, 11TH FLOOR, ARLINGTON, VA, 22203, US

(73) Assignee: British Telecommunications public limited company, London (GB)

(21) Appl. No.: 12/147,214

(22) Filed: Jun. 26, 2008

(30) Foreign Application Priority Data
May 2, 2008 (GB) 0808023.6

(51) Int. Cl. G06F 15/16

(52) U.S. Cl. 709/247; 709/246

(57) ABSTRACT

A method and system 13 for processing graphical data for transmission to a remote computer 15 via a data network 17, the graphical data representing an image or graphical model the display of which can be manipulated from the remote computer in real-time in accordance with control commands, for example in response to keyboard or mouse inputs 47. The method/system involves receiving, from the remote computer, image quality settings associated with respective manipulation modes. A current manipulation mode is identified based on control commands received from the remote computer, for example in response to detecting whether or not a user is interacting with the image or model. The graphical data is then processed in accordance with the image quality settings for the identified current manipulation mode to generate an updated image or set of images for transmission to the remote computer.

### FIELD OF THE INVENTION

This invention relates to a method and system for processing graphical data, for example data representing a three-dimensional model.

### BACKGROUND OF THE INVENTION

Computer applications providing visualisation in three-dimensions (3D) are known. For example, it is known to provide 3D visualisations of seismic and other geophysical data to enable scientists/engineers to evaluate terrain conditions in remote areas which can be useful for planning purposes, detecting potential operational problems and so on. Such applications generate huge datasets which make it difficult to distribute such models in an efficient way, particularly over data networks. In some countries, there are also legal restrictions in place which prevent the datasets leaving the country and which therefore oblige local processing. These size and access issues therefore require the dataset and processing functionality to be co-located and make remote access impractical. To exemplify this further, analysts of such models generally require large high resolution displays to view and manipulate the models which usually necessitates multiple monitor systems with powerful graphics cards for rendering the high resolution images. Therefore, in a conventional set-up, any data connection between the computer running the application and a user terminal would require bandwidth in the order or 50 Mbits/sec or greater.

Another challenge is the latency of the data connection. Analysing such models relies not only on image quality but also on the ability to manipulate the model, for example to zoom in/out of a particular part of the model, to scroll or rotate the model or to view a different region, and so on. Higher latency networks, such as the Internet or satellite-based networks, generally exhibit poor responsiveness to remote user input, especially with protocols that require multiple round trips to convey commands, keyboard inputs and/or mouse movement.

It would therefore be desirable to provide a method and system to improve remote access to graphical data, particularly where remote manipulation is also required.

FIG. 1 shows a typical prior art setup for viewing and manipulating a 3D model. An application server 1 is shown co-located with a user terminal 3 and being connected thereto with a high bandwidth connection 5. Located within the application server 1 is a storage facility 7 for storing the large amount of 3D model data, a graphics application 9 for generating the image data, representing requested image frames of the model, in accordance with control commands received from the user terminal 3. A graphics card/driver set 11 is also provided enabling output to the user terminal 3.

### SUMMARY OF THE INVENTION

In one sense, the invention provides a method of processing graphical data for transmission to a remote computer via a data network, the graphical data representing an image or graphical model the display of which can be manipulated from the remote computer in real-time in accordance with control commands, wherein the method comprises: receiving, from the remote computer, image quality settings associated with respective manipulation modes; identifying a current manipulation mode based on control commands received from the remote computer; and processing the graphical data in accordance with the image quality settings for the identified current manipulation mode to generate an updated image or set of images for transmission to the remote computer.

The method enables image processing to be performed locally, i.e. co-local with the image/model dataset, in accordance with quality settings particular to, and received from, a remote terminal. With restricted bandwidth between the two computers, this allows the user to control, in real-time, the quality of graphical data displayed at their end dependent on if and how the user is manipulating the data. For a given bandwidth, there is a trade-off between image quality and transmitted frame rate and the user has the ability to determine the degree to which one is preferred over the other. For example, in a first manipulation mode where there is, in fact, no manipulation, a higher image quality will usually be preferred over transmission rate since the displayed image will not change over successive frames. On the other hand, in a different manipulation mode where successively-transmitted image frames will change, e.g. due to a rotation command, the transmission rate becomes a factor. If the user requires a smooth transition between frames, a high frame transmission rate will be preferred at the expense of image quality.

In the preferred embodiment, respective image quality settings for such static and moving scenarios are set and transmitted from the client end. At said client end, the settings can be made using two slider bars which enable a user to adjust settings interactively and, taking into account some small amount of network latency, to view the resulting effects on the data received from the processing end. Dynamic control is therefore facilitated.

The image quality is preferably adjusted by its degree or type of compression. In the preferred embodiment, we employ a Discrete Wavelet Transform (DWT) algorithm based on JPEG2000 which is shown to improve the quality of images at higher levels of compression. Details of the JPEG2000 standard are available at http://www.jpeg.org/jpeg2000/. The algorithm provides multiple quality layers for an image. Accordingly, for each image to be transmitted to the remote computer, the image is preferably first compressed into multiple layers and, thereafter, layers are progressively transmitted depending on the current manipulation mode. Initially, the lowest quality layer is transmitted. If no new image (or a duplicate image) is required, then the image data comprising the next quality layer is sent. At the remote computer, the corresponding codec adds this to the previous layer and a higher quality image is displayed. This continues until either the image changes, e.g. due to manipulation, or all quality layers have been sent. This facilitates the interruption of the progressively improving image quality to recommence transmission of standard quality images in response to user manipulation.

A similar approach could also be taken to the transmission of Discrete Cosine Transform (DCT) algorithms such as JPEG by transmitting only improved accuracy data relating to the high frequency components of each DCT matrix and substituting it for the lower accuracy or zero value elements previously sent.

To clarify, by ‘manipulating’ or ‘manipulation’, we mean that the user performs some sort of input at the remote computer to interact with the application generating the images in a way which requires a change to the currently displayed image. This manipulation may involve, for example, zooming in or out, panning, scrolling or rotating to a different part of the model.

The invention may also provide a system for processing graphical data for transmission to a remote computer via a data network, the graphical data representing an image or graphical model the display of which can be manipulated at the remote computer in real-time in accordance with control commands, wherein the system comprises: means for receiving, from the remote computer, image quality settings associated with respective manipulation modes; means for identifying a current manipulation mode based on control commands received from the remote computer; and means for processing the graphical data in accordance with the image quality settings for the identified current manipulation mode to generate an updated image or set of images for transmission to the remote computer.

The method/system may utilise encryption to ensure security of transmission.

### BRIEF DESCRIPTION OF THE DRAWINGS

The invention will now be described, by way of example, with reference to the accompanying drawings in which:

FIG. 1 is a prior art system enabling user viewing and manipulation of a 3D model using a client terminal that is co-located with the 3D model data;

FIG. 2 is a block diagram of a system according to an aspect of the invention which enables remote viewing and manipulation via a lower bandwidth network connection;

FIG. 3 is a block diagram showing, in further detail, functional components of the system shown in FIG. 2;

FIG. 4 is a representation of a graphical user interface (GUI) presented at a client-end terminal for enabling presentation of, and interaction with, the 3D model;

FIG. 5 is a flow diagram indicating processing steps performed at an application server; and

FIG. 6 is a flow diagram indicating processing steps performed at a client-end computer terminal.

### DETAILED DESCRIPTION OF A PREFERRED EMBODIMENT

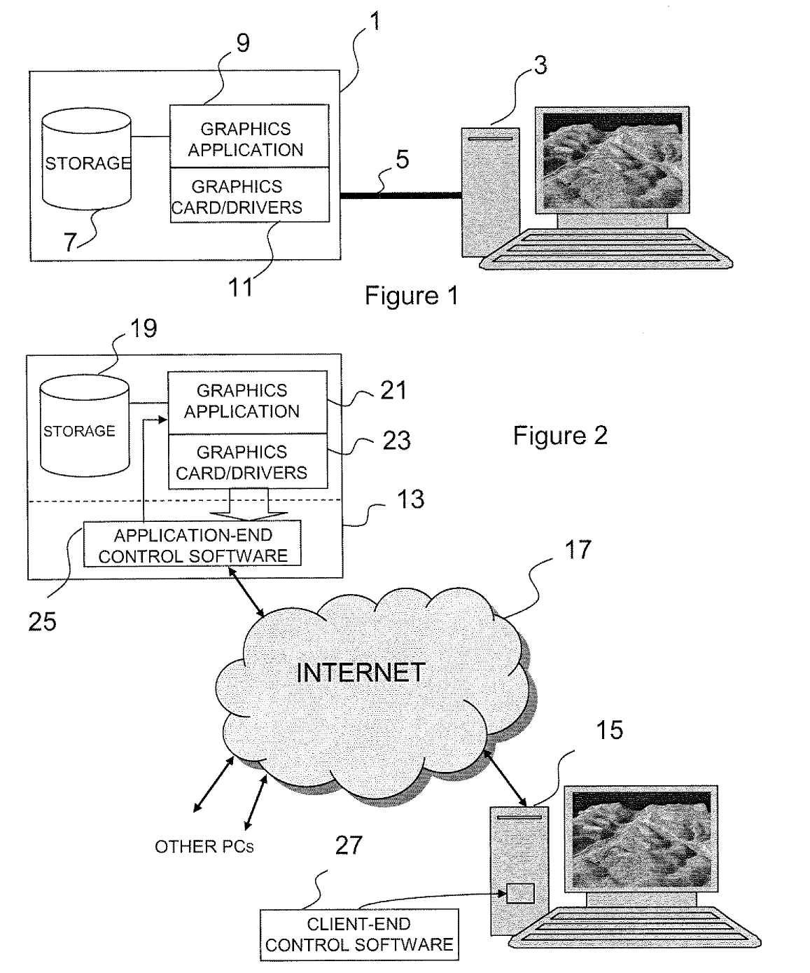

FIG. 1 was described above in relation to the prior art and is useful for understanding the background of the present method/system which is described with reference to FIGS. 2 to 4 of the drawings.

Referring to FIG. 2, an application server 13 is shown connected to a client terminal 15 via the Internet 17. The Internet 17 is used as the intervening data network in this embodiment since it exemplifies the sort of lower-bandwidth, higher-latency network with which the method/system offers particular advantages. A satellite network has similar bandwidth/latency issues, although the reader will appreciate that it is not intended to restrict the method/system to these network types.

The application server 13 is similar to that shown in FIG. 1 in that it comprises a storage facility 19 for storing 3D model data, a graphics application 21 and graphics card/drivers 23. In addition, however, we provide application-end control software 25 which, in effect, sits between the graphics application 21 and the remote user terminal 15 and operates in such a way as to process the 3D model data such that it can be transmitted over the ‘lower’ bandwidth Internet 17 and viewed at the user terminal in an improved manner. The nature of this processing, which involves image compression, is dependent on user settings made at the user terminal 15 and a determination as to whether the user is interacting with the model, for example by manipulating the model to zoom/rotate/pan/scroll from what is currently shown. Further details of this control software 25, its interaction with the user terminal 15, and the image processing will be described later on. At the user terminal 15, client-end control software 27 is arranged to communicate with the application software 25 in order to transfer various sets of user settings and interaction data to the application-end software and to receive the processed 3D model data for display in a graphical user interface (GUI).

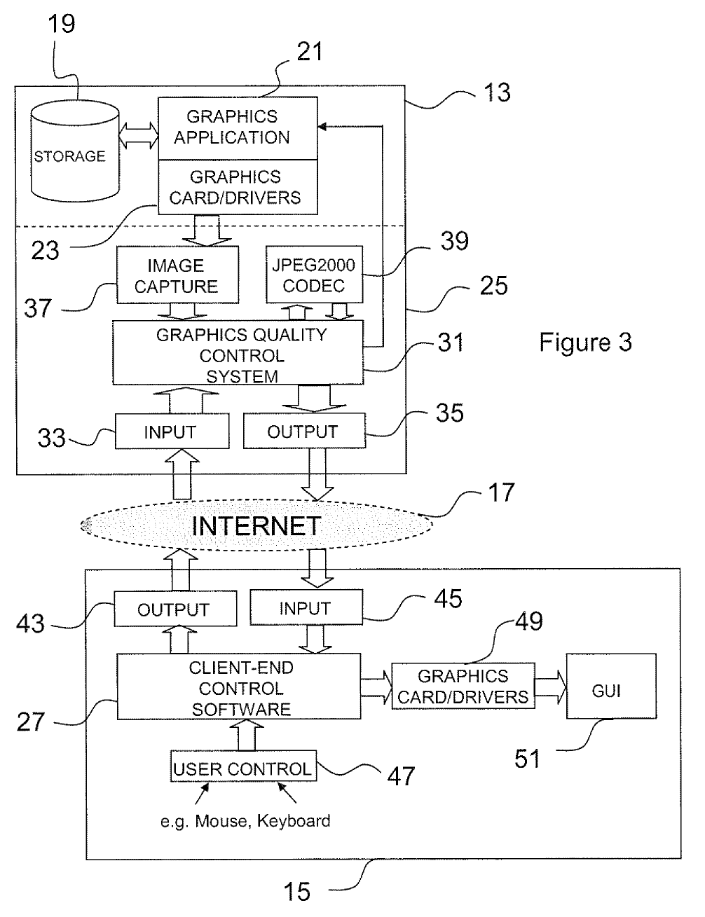

Referring to FIG. 3, functional components of the application server 13 and user terminal 15 are shown in greater detail. Components of the application software 25 include an image capture component 37, a JPEG2000 codec 39, a graphics quality control system 31 (hereafter referred to simply as the QCS) and input and output interfaces 33, 35. As indicated above, image processing at the application server 13 employs compression to control the amount of data that needs to be transmitted over the Internet 17. Here, we use the JPEG2000 codec 39 to encode captured images but it should be appreciated that, in principle, other compression codecs may be employed. JPEG2000, or similar DWT variants, are particularly useful in that they have been found to improve perceived image quality for higher levels of compression. The fact that such codecs involve progressive layering of different quality layers is also used in this system to increase image quality in the presence of zero or little user interaction.

At the user terminal 15, client-end control software 27 (hereafter referred to as the client software) transmits and receives data to/from the Internet 17 via respective output and input interfaces 43, 45. As indicated above, transmitted data will include user settings and/or user control signals 47, the latter resulting from, for example, mouse or keyboard inputs when a user manipulates the model being presented on their display. Data received by the client software 27 will comprise image data transmitted from the application software 25 representing updated images of the model for display on a graphical user interface (GUI) 51 using a suitable graphics card/driver 49.

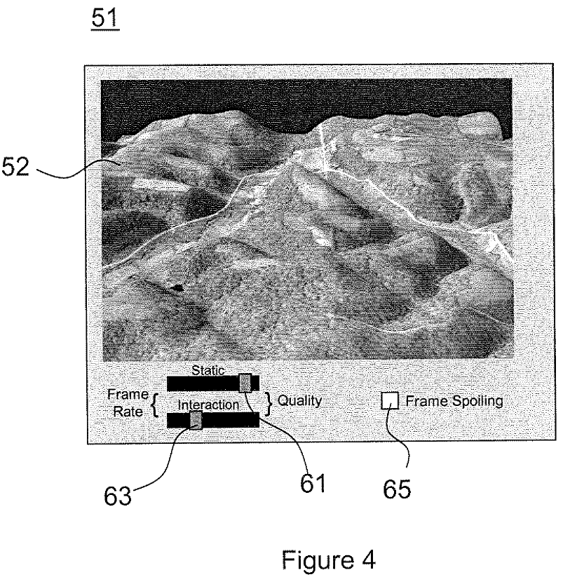

In addition to the above, the client software 27 permits the user to dynamically control how the 3D model data is transmitted from the application server 13 in terms of image quality and transmitted frame rate. With it in mind that the Internet connection 17 will have limited bandwidth (certainly too limited for the model to be transmitted as full resolution images at, say, 25 frames/sec) the user can make a trade-off between image quality and transmitted frame rate to suit their bandwidth characteristics. Indeed, a respective setting is permitted for more than one interaction mode, i.e. so there is a first setting for when there is zero or little interaction and a second setting for when the user is interacting/manipulating the model. This takes account of the fact that, where there is no or little interaction, it is not necessary to transmit fresh images and so the user may prefer to view high quality images with minimal compression. Where there is interaction, image updates will be required and so the update rate may be preferred in favour of image quality, particularly if a smooth scrolling effect is desired at the GUI 51. There are no hard and fast rules in this respect, and it is left entirely to the user to make their choices via the client software's GUI 51. An example of the GUI 51 is shown in FIG. 4 where, in addition to a main image screen 52 for presenting the model, there are provided first and second slider bars 61, 63 for adjusting settings in the static and interaction/manipulation modes respectively. A further ‘frame spoiling’ option 65 is available; this permits the client software 27 to request disposal of any incoming frames it cannot handle in order to free up processing speed. Excess frames are discarded at the application end and this allows frames to be discarded where there is a queue for compression or transmission. This speeds up the apparent application speed as it is not waiting for frame transmission, but at the expense of apparent jerky movement of the displayed image as intervening frames are discarded.

The operation of the system shown in FIG. 3 will now be described.

Initially, when a user runs the client software 27 at user terminal 15, a connection will be established with the application software 25 via the Internet 17 and the client software 27 will open the GUI indicated in FIG. 4. The slider bars 61, 63, which determine the settings for the different interaction/manipulation modes, will initially have default values which are sent to the QCS 31. Upon receipt of the default values, QCS 31 commences transmitting images of the model's current view with a compression and frame rate determined by said default settings. Given that the values can be updated dynamically by the user, these values are re-transmitted to the QCS 31 whenever they are changed to ensure the resulting effect of any change can be seen at the GUI 51 in real time, or at least something approaching real time.

The setting values for quality and frame rate can be specified in the setting data, or, as in this case, given there is a predetermined relationship between the two parameters, only one need be derivable by the application software 25 in order to obtain the other (assuming the application software stores the predetermined relationship).

When the user interacts with the model, for example to rotate the model to a different viewing angle by dragging the mouse controller over the model, the resultant control signals are transmitted from the client software 27 to both the graphics application 21 (i.e. to identify how the model is to be translated and which new images need to be acquired from storage) and to the QCS 31 which identifies that the interaction/manipulation mode is now applicable. In response, the graphics application 21 acquires the new data from storage, outputs the visualisation using the graphics card 23 whereafter each image is captured and compressed by the JPEG2000 codec 39 into its multi-layer format. The degree of JPEG2000 compression is determined by the current frame rate v quality setting for the interaction/manipulation mode, as received by the QCS 31, as is the transmission rate.

Next, each image is transmitted by the QCS 31 to the client software 27 at the determined transmission rate. This continues for as long as the user is interacting at the client end 15. When the user stops interacting, the QCS 31 will detect a return to the non-interaction mode and so the other set of rate v quality settings (which may of course have changed since they were last used) will be applied. In this case, it may be that the settings cause the frame rate to drop significantly in favour of less compressed, higher resolution images. We only use the higher quality for a static image, so the frame rate is zero once this image at all quality layers is transmitted.

Since we are using an image compression codec 39 that provides the compressed image as multiple quality layers, the QCS 31 will send the lowest quality layer first with the next quality layers subsequently being sent in order of progressing quality. The lowest quality layer may correspond to the current setting for the particular interaction mode. At the client software 27, the corresponding decoding codec is arranged such that, as each layer is received, it is added or combined with all previously received layers so that image quality improves progressively so long as there is no interaction. This continues until either a changed frame is received by the client software 27 or all quality layers have been received. This allows image quality to increase beyond that specified in the user's settings provided there is little or no interaction. It also facilitates interruption of improving image quality to recommence the transmission of lower quality images in response to a user input or some other change to the image.

It should be noted that, unlike standard multiple quality layer algorithms, such as JPEG2000, where the quality layers are transmitted as a single file or message, we modify the transmission method by transmitting each layer in a distinct, separate file or message. The layer having the highest compression (lowest quality) is transmitted first, then the layer having the next highest compression (next lowest quality) is sent, and so on. Initially, therefore, the transmitted message is small with subsequent ones increasing in size.

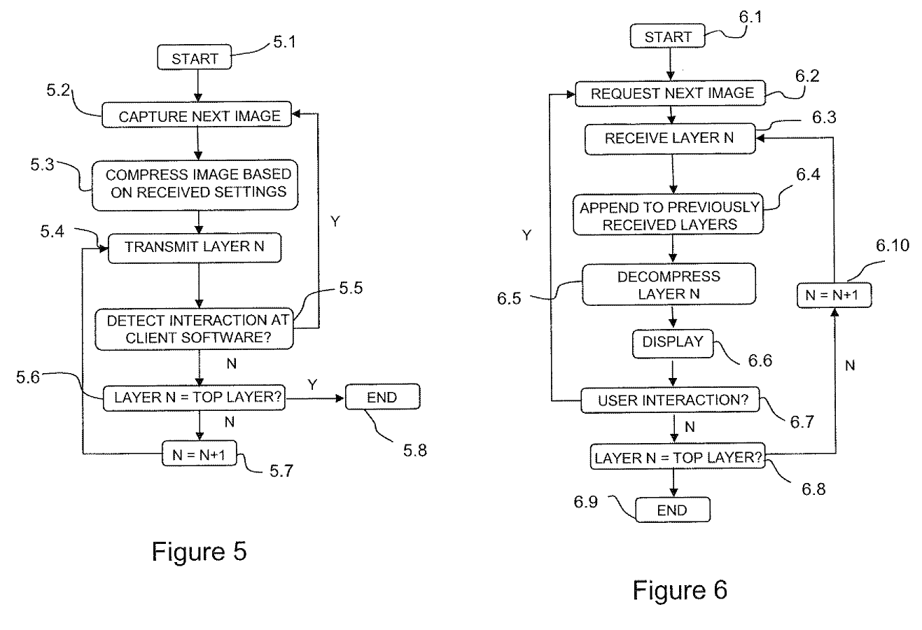

Referring to FIG. 5, steps performed by the application software 25 at the server end are shown. Following the initial state 5.1, the next image to be transmitted from the graphics application 21 is captured in step 5.2. In step 5.3, this captured image is compressed using the JPEG2000 algorithm based on the settings data received from the client end 15. As indicated above, this involves generating a plurality of quality layers, each of which represents the compressed image at a different quality level. In step 5.4, a quality layer N is transmitted to the client end 15, N being the first (and lowest) quality layer in this case. In the event that interaction is detected at the client end 15 (step 5.5), the method returns to step 5.2 and the next image is captured. Without interaction, it is determined in step 5.6 whether the last layer was the top (and highest) quality layer. If so, the process ends at step 5.8 until there is some interaction at the client end 15. If there are further layers to be sent, step 5.7 increments the layer count, the method returns to step 5.4 and the next quality layer is transmitted to the client end 15.

Referring to FIG. 6, steps performed by the client software 27 at the client end 15 are shown. Following the initial state 6.1, the next image to be displayed is requested in step 6.2. In response, in step 6.3, a first quality layer N for the requested image is received from the application software 25. In step 6.4, the received quality layer is added to previously-received quality layers for the current frame. At this stage, there are no previously-received layers. In step 6.5, the received quality layer (or, if the previous step involved combining, the combined quality layers) is/are decompressed and, in step 6.6, displayed at the GUI 51. If user interaction occurs (step 6.7), a new image will be requested from the application-end control software 25 as in step 6.2. Without interaction, it is determined in step 6.8 whether the last layer was the top (and highest) quality layer. If so, the process ends at step 6.9 with the highest quality version of the decompressed image being displayed. If further layers are to be sent from the application-end control software 25, step 6.10 increments the layer count, the method returns to step 6.3 and the next quality layer is awaited from the server end 13.

The above steps assume that the compression/decompression algorithm does not employ tiling. The skilled reader will appreciate that some algorithms divide the image into a number of distinct ‘tile’ regions with each one being compressed and transmitted separately. Where a tiling algorithm is employed, step 5.4 will involve transmitting the current layer N for each tile and step 6.3 will involve receiving the current layer N for each tile.

It will be appreciated that the above-described method and system enables remote user access to otherwise large data sets over a standard network connection by means of adjusting processing characteristics of the image, in terms of compression and transmission rate in this case, dependent on user-defined preferences for a plurality of interaction/manipulation modes. The majority of the image processing is performed locally, i.e. at the application server 13, with the client software only having to transmit relatively small sets of control data and thereafter decode the compressed image data received over the Internet.

Further preferred features of the method and system will now be summarised.

The method may include receiving a set of initial operating parameters with a preference for quality or frame rate. The degree of compression may be altered in response to changing connection conditions within the general parameters for the type of connection (e.g. maximum bandwidth utilisation or minimum frame rate). The degree or type of compression may be altered automatically depending on whether the input image is changing. Hardware acceleration of the compression may be employed to minimise impact on applications running on the same machine and to generate sufficient frame rate for transmission. At the remote computer, where a higher received frame rate is required, the hardware acceleration of the decompression may be employed to minimise the impact on applications running on the same machine. Where a lower frame rate is acceptable, a software-only implementation of the client can be provided.

The method/system can establish a base level of compression and frame rate based upon the nature of the communications link. The user may set a preference for quality or frame rate within the parameters appropriate for the communications link. The method/system may enable altering of the size/quality of the images being transmitted at any time. and the ability to change the degree of compression required for each individual frame in response to conditions on the communications line to either maintain a given quality or a given frame rate depending upon the preference set by the user.

The method/system may determine if the current image to be transmitted differs from the previous image in only a few areas and, if so, operates to reduce the data transmitted by applying a mask such that the remaining (unchanged areas) of the image are treated as a single colour or shade, for example black. This allows higher levels of compression or a higher image quality to be sent for a given image size. The image is transmitted along with the details of the mask used and which areas are ‘blacked out’. When the image is decompressed, the previous image is redisplayed but with only the changed areas modified. This reduces the edge-of-tile artefacts that are often visible with a conventional tiling approach where each tile is individually compressed and decompressed. Straightforward tiling would produce boundary artefacts. In our method/system, we ‘black out’ the inner 90%, say, of an image (area) to allow compression across the boundaries, thereby reducing boundary artefacts.

The method/system may involve the incorporation of filters or similar image processing to further reduce visible compression or tiling artefacts.

The method/system may be configured to check for duplicate frames being sent by the application. This allows duplicate checking to be disabled for applications that do not transmit duplicates and therefore speed up processing. Where duplicate checking is enabled, and a duplicate frame is detected, it is treated as though no new frame had been received.

The method/system may determine whether there is no new image to display and, if so, a higher quality version of the current image is to the recipient to improve the clarity of their display. This higher quality image may be progressively displayed.

Where a method of image compression is used that allows the compressed image to contain multiple quality layers then the standard quality image transmission may be the lowest quality layer. If no new frame, or if a duplicate frame is received then the image data comprising the next quality layer can be sent. This is added to the previously received data and a higher quality image is displayed. This may continue until either a changed frame is received or all quality layers are sent. This facilitates the interruption of the improving image quality to recommence the transmission of standard quality images in response to a user input or change to the image.

The method/system may involve truncating parts of the compressed image stream relating to the colour components of the image to achieve a smaller image size for a given perceived image quality. This may be enabled or disabled dynamically by the user, or optionally in response to communications conditions.

The compression, and other aspects of image manipulation at the application server, may be undertaken either in software or in a hardware device comprising the appropriate processing configurations. These may contain either reprogrammable hardware such as Field Programmable Gate Arrays (FPGAs) or dedicated permanently-configured hardware such as Application Specific Integrated Circuits (ASICs), or a combination of both. Similarly, the decompression and other aspects of image manipulation at the client may be undertaken either in software or may be undertaken in hardware containing the appropriate processing configurations, e.g. FPGAs and/or ASICs.

The hardware device may be housed on a card that can be inserted into the serving computer using a standard interface (e.g. PCI Express) or in a separate housing connected by an interface cable. Where the hardware is reprogrammable then the invention preferably allows amendment of the embedded program to facilitate the addition of new features or the correction of defects.

The method/system may utilise a proxy software service to minimise the amount of other repetitive application traffic passing over the network. The transmission of the 3D image and its associated data may be on a separate logical connection from other (non-3D) image data or from the keyboard and mouse inputs to facilitate the best image transmission while still allowing the system to be responsive to user inputs. The type of proxy may vary according to operating system in use and the invention may be incorporated into existing thin client technologies e.g. Citrix, VNC etc.

1. A method of processing graphical data for transmission to a remote computer via a data network, the graphical data representing an image or graphical model the display of which can be manipulated from the remote computer in accordance with control commands, wherein the method comprises: receiving, from the remote computer, image quality settings associated with respective manipulation modes; identifying a current manipulation mode based on control commands received from the remote computer; and processing the graphical data in accordance with the image quality settings for the identified current manipulation mode to generate an updated image or set of images for transmission to the remote computer.

2. A method according to claim 1, wherein the received image quality settings include at least one of image resolution and transmission frame rate settings.

3. A method according to claim 2, wherein if just one of said settings is received, the other setting is derivable using a stored predetermined relationship between image resolution and transmission frame rate.

4. A method according to claim 1, wherein the processing step includes applying a compression algorithm to an image, or in the case of a graphical model, an image taken from said model, the compression algorithm being arranged to generate a plurality of image layers, each providing a compressed version of the image with a different quality level.

5. A method according to claim 4, further comprising transmitting each image layer so generated to the remote computer, the layers being transmitted as separate files/messages and in sequence from the lowest quality layer upwards.

6. A method of interacting with a remote graphics system over a data network, the remote graphics system being arranged to process graphical data representing an image or graphical model the display of which can be manipulated remotely by user input, the method comprising: transmitting to the remote graphics system (i) image quality settings associated with respective manipulation modes, and (ii) control commands indicative of, or from which can be derived, a current manipulation mode; and subsequently receiving one or more images back from the remote graphics system, the images having been processed in accordance with the image quality settings for the current manipulation mode.

7. A computer program, or suite of computer programs, stored on a computer readable medium and being arranged, when run on a processing system, to perform the steps defined in claim 1.

8. A system for processing graphical data for transmission to a remote computer via a data network, the graphical data representing an image or graphical model the display of which can be manipulated from the remote computer in real-time in accordance with control commands, wherein the system comprises: means for receiving, from the remote computer, image quality settings associated with respective manipulation modes; means for identifying a current manipulation mode based on control commands received from the remote computer; and means for processing the graphical data in accordance with the image quality settings for the identified current manipulation mode to generate an updated image or set of images for transmission to the remote computer.

9. A system enabling interaction with a remote graphics system over a data network, the remote graphics system being arranged to process graphical data representing an image or graphical model the display of which can be manipulated remotely by user input, the interaction system comprising: means for transmitting to the remote graphics system (i) image quality settings associated with respective manipulation modes, and (ii) control commands indicative of, or from which can be derived, a current manipulation mode; and means for subsequently receiving one or more images back from the remote graphics system, the images having been processed in accordance with the image quality settings for the current manipulation mode.
